(19) United States
(12) Patent Application Publication
(10) Pub. No.: US 2025/0252969 A1
(43) Pub. Date: Aug. 7, 2025

(54) AUDIO PROCESSING METHOD AND APPARATUS, STORAGE MEDIUM, AND ELECTRONIC DEVICE

(71) Applicant: Beijing Bytedance Network Technology Co., Ltd., Shijingshan District, Beijing (CN)

(72) Inventors: Weihao XIONG, Beijing (CN); Xinquan ZHOU, Beijing (CN)

(21) Appl. No.: 18/853,079

(22) PCT Filed: Mar. 14, 2023
(86) PCT No.: PCT/CN2023/081227

§ 371 Date: Sep. 30, 2024

(30) Foreign Application Priority Data
Apr. 8, 2022 (CN) 202210367406.8

(51) Int. Cl. G10L 25/84; G10L 15/06; G10L 25/78

(52) U.S. Cl. CPC G10L 25/84; G10L 15/063; G10L 2025/786

(57) ABSTRACT

An audio processing method and apparatus, a storage medium, and an electronic device. The audio processing method includes: acquiring an audio frame to be processed and determining an audio type of the audio frame based on a current recognition threshold; in response to a determination that a current audio frame satisfies a threshold adjustment condition, determining a determination state of a recognized audio type based on characteristic information of recognized continuous audio frames; and adjusting the current recognition threshold according to the determination state, wherein the adjusted recognition threshold is configured to recognize the audio type of a next audio frame.

The present application claims priority to the Chinese patent application No. 202210367406.8 filed with the CNIPA on Apr. 8, 2022, which is incorporated herein in its entirety by reference.

### TECHNICAL FIELD

The embodiments of the present disclosure relate to the technical field of data processing, for example, an audio processing method and apparatus, a storage medium and an electronic device.

### BACKGROUND

With the continuous development of the Internet and communication technology, audio recognition has attracted more and more attentions from users in fields such as communication systems and voice recognition.

Currently, audio recognition can be performed by setting a constant threshold, but the recognition accuracy of this method is poor.

### SUMMARY

Embodiments of the present disclosure provide an audio processing method and apparatus, a storage medium, and an electronic device to improve the accuracy of audio recognition.

In a first aspect, an embodiment of the present disclosure provides an audio processing method, including:
acquiring an audio frame to be processed and determining an audio type of the audio frame based on a current recognition threshold;
in response to a determination that a current audio frame satisfies a threshold adjustment condition, determining a determination state of a recognized audio type based on characteristic information of recognized continuous audio frames; and
adjusting the current recognition threshold according to the determination state, wherein the adjusted recognition threshold is configured to recognize the audio type of a next audio frame.

In a second aspect, an embodiment of the present disclosure also provides an audio processing apparatus, including:
a type determination module, configured to acquire an audio frame to be processed and determine an audio type of the audio frame based on a current recognition threshold;
a state determination module, configured to determine a determination state of the recognized audio type based on characteristic information of recognized continuous audio frames in response to a determination that a current audio frame satisfies a threshold adjustment condition; and
a threshold adjustment module, configured to adjust the current recognition threshold according to the determination state, wherein the adjusted recognition threshold is configured to recognize the audio type of a next audio frame.

In a third aspect, an embodiment of the present disclosure further provides an electronic device, including:
one or more processors;
a storage device configured to store one or more programs,
when the one or more programs are executed by the one or more processors, the one or more processors are configured to implement the audio processing method as described in any embodiment of the present disclosure.

In a fourth aspect, an embodiment of the present disclosure further provides a storage medium comprising computer-executable instructions, wherein the computer-executable instructions, when executed by a computer processor, are configured to implement the audio processing method described in any embodiment of the present disclosure.

### BRIEF DESCRIPTION OF DRAWINGS

Throughout the drawings, the same or similar reference numerals refer to the same or similar elements. It is to be understood that the drawings are schematic and that components and elements are not necessarily drawn to scale.

FIG. 1 is a schematic flow chart of an audio processing method provided by an embodiment of the present disclosure;

FIG. 2 is a schematic flow chart of an audio processing method provided by an embodiment of the present disclosure;

FIG. 3 is a schematic flow chart of an audio processing method provided by an embodiment of the present disclosure;

FIG. 4 is a schematic flow chart of an audio processing method provided by an embodiment of the present disclosure;

FIG. 5 is a schematic structural diagram of an audio processing apparatus provided by an embodiment of the present disclosure; and

FIG. 6 is a schematic structural diagram of an electronic device provided by an embodiment of the present disclosure.

### DETAILED DESCRIPTION

It is to be understood that multiple steps described in the method implementations of the present disclosure may be executed in different orders and/or in parallel. Furthermore, the method embodiments may include additional steps and/or omit performing the illustrated steps. The scope of the present disclosure is not limited in this regard.

As used herein, the terms “comprise/include” and its variations are open-ended, i.e., “including but not limited to”. The term “based on” refers to “based at least in part on”. The term “an embodiment” refers to “at least one embodiment”; the term “another embodiment” refers to “at least one additional embodiment”; and the term “some embodiments” refers to “at least some embodiments”. Definitions of other terms will be given in the description below.

It is to be noted that concept such as “first” and “second” mentioned in the present disclosure are only used to distinguish different devices, modules, or units, and are not used to limit the order of functions performed by these devices, modules, or units, or interdependences thereof.

It is to be noted that the modifications of “one” and “a plurality of” mentioned in the present disclosure are illustrative and not restrictive. Those skilled in the art will understand that it should be understood as “one or more,” unless the context clearly indicates otherwise.

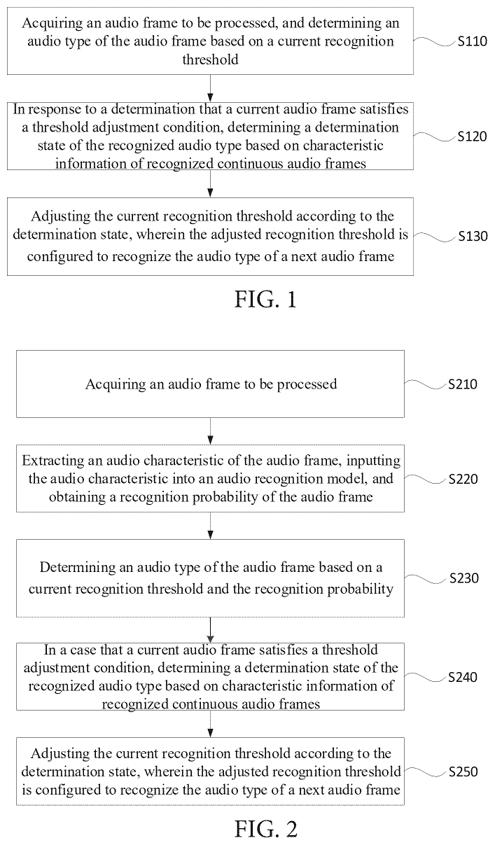

FIG. 1 is a schematic flow chart of an audio processing method provided by an embodiment of the present disclosure. The embodiment of the present disclosure is adapted to perform recognition of audio type based on an automatically adjusted threshold. This method can be executed by an audio processing apparatus provided by an embodiment of the present disclosure. The audio processing apparatus can be implemented in the form of software and/or hardware, for example, through an electronic device, and the electronic device can be a mobile terminal, or a PC, etc. As shown in FIG. 1, the method in this embodiment includes:
S110. Acquiring an audio frame to be processed, and determining an audio type of the audio frame based on a current recognition threshold.
S120. In a case that a current audio frame satisfies a threshold adjustment condition, determining a determination state of the recognized audio type based on characteristic information of recognized continuous audio frames.
S130. Adjusting the current recognition threshold according to the determination state, wherein the adjusted recognition threshold is configured to recognize the audio type of a next audio frame.

In the embodiment of the present disclosure, the execution subject (the above-mentioned electronic device) configured to execute the audio processing method includes but is not limited to devices such as mobile phones, smart watches, or computers. The above-mentioned electronic device can obtain the audio frame to be processed in a variety of ways. For example, audio data can be collected in real time through an audio acquisition device, and audio frames to be processed can be extracted from the audio data. Audio data can also be retrieved from a preset storage location or other devices, and audio frames to be processed can be extracted from the audio data. The disclosed embodiments do not limit the method of acquiring audio frames to be processed. The above-mentioned audio data may include but be not limited to audio data from phone calls, audio data in videos, audio data in live streaming, etc., which is not limited herein.

The audio data may be a piece of audio, and the audio may contain information such as voice, noise, etc. The time length of the audio data is not limited in this embodiment. In order to improve the recognition accuracy of the audio data and improve the real-time processing of the audio data, the audio data is divided into multiple audio frames, and recognition processing is performed on each audio frame in real time. When the audio data is real-time data, the audio data collected in real time is divided into audio frames in sequence, and the obtained audio frames are recognized and processed in real time. When the audio data is offline data, the multiple audio frames can be processed sequentially according to a timing sequence of dividing the audio frames. The audio frame may be audio data with a preset time length, the time length of the audio frame may be determined based on the recognition accuracy, which is not limited herein. For example, the time length of the audio frame may be 10 ms. In this embodiment, the audio frame to be processed may be the audio frame that currently needs to be processed.

In this embodiment, audio types are recognized for multiple voice frames based on dynamic recognition thresholds. For the audio frame to be processed, the current recognition threshold corresponding to the processing time of the audio frame to be processed is obtained. The current recognition threshold can be a determination threshold corresponding to the processing time of the current audio frame, which determination threshold can be configured to determine the audio type of the audio frame. It is to be noted that the recognition threshold is an adjustable value, and the current recognition threshold can be an adjusted recognition threshold based on the previous voice frame, or it can be an unadjusted, initial recognition threshold.

In this embodiment, the audio type is recognized for the audio frame. The audio type can be set according to the recognition requirements. In some embodiments, the audio type is classified into voice type and noise type according to whether the audio frame contains noise; in some embodiments, the audio type may be classified according to the object that emits the sound such as human voice, rain sound, bird song, etc.; in some embodiments, the audio frame may also be classified into types such as song, speech, etc., which is not limited herein. For example, the audio type includes voice type and noise type. Among them, the audio frame corresponding to the voice type is a voice frame, the voice frame can include voice information, and the voice information can be a real language content; the audio frame corresponding to the noise type is a noise frame, the noise frame can include noise information, and the noise information can be interference information that has nothing to do with the language content, such as interference sounds generated in the environment.

On the basis of the above embodiments, the audio frame may be recognized based on a preset audio recognition algorithm to obtain the recognition probability of the audio frame, and the preset audio recognition algorithm is a recognition algorithm adapted to the recognition requirements of the audio type. In some embodiments, the audio recognition algorithm may be a machine learning model, and the machine learning model may be a neural network model, etc., which is not limited herein. The recognition probability of the audio frame is determined based on the current recognition threshold, and then the audio type of the audio frame is determined. Taking the audio type including voice type and noise type as an example, when the recognition probability of the audio frame is greater than or equal to the current recognition threshold, the audio frame is determined to be a voice frame; when the recognition probability of the audio frame is less than the current recognition threshold, the audio frame is determined to be a noise frame. It is to be noted that the recognition threshold can be one or more pieces of data, and the number of the recognition thresholds and the way of determining the recognition probability of the audio frame can be set according to the determination requirements of the audio type, which is not limited herein.

In this embodiment, the recognition threshold can be dynamically adjusted. For example, it can be adjusted in real time based on the determination state of the recognized voice frame. The adjusted recognition threshold is more suitable for the determination state of the next audio frame, so that a higher accuracy of recognizing the audio type can be obtained through the adjusted recognition threshold. The adjusted recognition threshold can be configured to recognize the audio type of the next audio frame, that is, continue to adjust the recognition threshold during the process of recognizing the next audio frame, thereby realizing a dynamic adjustment of the recognition threshold, which can be adapted to different environments and improve the recognition accuracy of the audio type.

It is to be noted that after the recognition of each voice frame is completed, it is determined whether the threshold adjustment condition is met. If the threshold adjustment condition is met, the current recognition threshold is adjusted, and the next audio frame is recognized based on the adjusted recognition threshold. If the threshold adjustment condition is not met, the current recognition threshold is kept unchanged, and the next audio frame is recognized based on the current recognition threshold, so as to avoid frequent adjustments of the recognition threshold and to avoid an interference to the recognition of audio type resulted by frequent adjustments of the recognition threshold.

In the embodiment of the present disclosure, the threshold adjustment condition may be a condition set by using the characteristics of continuous audio frames of voice type, which may include, but be not limited to, a condition for determining whether the voice is ended; that is to say, the threshold adjustment condition may be configured to filter out voice segments which have been interrupted or paused. For example, the threshold adjustment condition includes: the audio type of the current audio frame is a noise type, and the audio type of the previous audio frame is a voice type.

It is to be understood that, in a piece of audio, if the audio type of the current audio frame is a noise type and the audio type of the previous audio frame is a voice type, it indicates that there may be a voice interruption in the piece of audio, that is, the voice pauses or terminates, etc. The threshold adjustment condition is configured to determine whether a piece of audio of voice type is ended or not. When a piece of audio of voice type is ended, this piece of audio of voice type is then verified, that is, an overall verification is performed to multiple audio frames to determine whether it is a voice by considering the audio as a whole; and then the determination state of the recognized audio type is obtained to determine whether the setting of the current recognition threshold is appropriate. This determination method is more reliable and can avoid misjudgment of the audio type based on a single audio frame.

The recognized continuous audio frames may be a series of continuous audio frames for which recognition of audio type has been completed, that is, multiple audio frames having been continuously recognized as a voice type. The recognized continuous audio frames may be an audio segment at the end of a piece of voice which is immediately preceding the current audio frame; that is, the last audio frame of the recognized continuous audio frames is the previous audio frame of the current audio frame. The characteristic information of the recognized continuous audio frames refers to the reference information configured to determine whether the recognized audio type is correct. The characteristic information can be obtained by calculation or statistics of the basic information of the recognized continuous audio frames. The recognized audio type refers to the overall type of continuous audio frames, that is, the audio type corresponding to a recognized piece of audio, rather than the audio type of a single audio frame. The determination state refers to the state indicating whether the recognized audio type is correct or wrong.

Based on the above embodiments, the characteristic information includes one or more of the following: a length, a recognition probability, a fundamental frequency, and an energy value of continuous voice frames.

Among them, the length of the continuous voice frames refers to the time length of continuous voice frames, which can be obtained statistically; that is, the sum of the time lengths of multiple audio frames in the continuous voice frames. The recognition probability refers to the probability that the continuous voice frames are of the voice type; for example, it may be the average probability that multiple voice frames in the continuous voice frames are of the voice type. The fundamental frequency refers to the frequency at which the vocal cord vibrates; for example, the fundamental frequency of the continuous voice frames may be an average value of the fundamental frequencies of multiple voice frames in the continuous voice frames. The energy value of the continuous voice frames may be the sum or the average energy value of energy values of multiple voice frames in the continuous voice frames. It is to be noted that the above characteristic information all can be obtained through statistics, calculation, etc., and will not be described again here.

Exemplarily, effective voice segments (that is, continuous audio frames of voice type) have the characteristics of longer time length, higher recognition probability, higher fundamental frequency or larger energy value. A time length determination threshold, a probability determination threshold, a frequency determination threshold, or an energy determination threshold can be set to determine the characteristic information of the continuous audio frames, so as to determine whether the determination result of the audio type of the continuous audio frames is correct or not, and to obtain the determination state of the recognized audio type. For example, if the characteristic information is greater than the corresponding setting threshold, it indicates that the determination state is correct; if the characteristic information is less than or equal to the corresponding setting threshold, it indicates that the determination state is error.

In some exemplary implementations of embodiments of the present disclosure, determining the determination state of the recognized audio type based on the characteristic information of the recognized continuous audio frames includes: determining characteristic information of continuous voice frames preceding the current audio frame; comparing the characteristic information with a determination threshold of the characteristic information; determining a determination state of the recognized audio type based on a comparison result.

For example, the characteristic information of the continuous voice frames preceding the current audio frame can be obtained through methods such as calculation, or statistics, and can include one or more pieces of information; that is, the continuous voice frames preceding the current audio frame can have one or more pieces of characteristic information. It can be understood that when there are multiple pieces of characteristic information, the evaluation parameters for determining the state are more abundant, which can improve the accuracy of state judgement. The determination threshold of characteristic information can be set based on experience, and can include one or more determination thresholds, that is, the characteristic information can have one or more determination thresholds. After the characteristic information and the corresponding determination threshold are determined, the characteristic information and the determination threshold of the characteristic information are compared one by one to obtain the comparison result, and then the determination state of the recognized audio type is determined based on the comparison result, wherein there is a mapping relationship between the comparison result and the determination state. For example, if the multiple pieces of characteristic information are all greater than the determination threshold of the characteristic information, it's determined that the determination state of the recognized audio type is correct; if at least one piece of characteristic information among the multiple pieces of characteristic information is less than or equal to the determination threshold of the characteristic information, it's determined that the determination state of the recognized audio type is error. In this embodiment, the state determination is performed through threshold comparison. This method is simple and efficient, and can quickly verify the audio type of the recognized continuous voice frames.

In some example embodiments, the length of continuous voice frames and the average recognition probability are determined. The length of the continuous voice frames is judged based on the time length threshold, and the average recognition probability is judged based on the recognition probability threshold. When the length of the continuous voice frames is greater than the time length threshold, and the average recognition probability is greater than the recognition probability threshold, it's determined that the determination state of the recognized audio type is correct; when the length of the continuous voice frames is less than or equal to the time length threshold, and/or, when the average recognition probability is less than or equal to the recognition probability threshold, it's determined that the determination state of the recognized audio type is error.

In some exemplary implementations of embodiments of the present disclosure, the determination state includes an error state and a correct state, and the current recognition threshold is adjusted according to the determination state, wherein the adjustment method of the current recognition threshold includes increasing and decreasing the current recognition threshold. For example, when the determination state is an error state, the current recognition threshold is increased; when the determination state is a correct state, the current recognition threshold is decreased.

Among them, the error state indicates an error in the judgement of the recognized audio type, indicating that the noise with a short time length, a small recognition probability, a low fundamental frequency, or a small energy value is recognized as a voice, so the current recognition threshold needs to be increased to prevent from subsequent identification of this type of noise as a voice; the correct state indicates that the recognized audio type has been determined correctly, and when the determination state is a correct state, the current recognition threshold can be decreased and the criterion for recognition probability can be relaxed. It is to be noted that if the current recognition threshold is increased to the upper threshold, or the current recognition threshold is reduced to the lower threshold, the current recognition threshold will not continue to be increased or decreased to prevent from over-adjustment, which may lead to occurrence of the accuracy of audio recognition.

In the technical solution of the embodiment of the present disclosure, the audio frame to be processed is acquired, which indicates that this solution is to process the audio data in frames, so as to determine the audio type of the audio frame based on the current recognition threshold, and achieve a preliminary determination of the type of the audio frame; when the current audio frame satisfies the threshold adjustment condition, the determination state of the recognized audio type is determined based on the characteristic information of the recognized continuous audio frames, and the audio type of the recognized continuous audio frames can be re-verified; the current recognition threshold is adjusted based on the re-verified determination state, and the adjusted recognition threshold can be configured to recognize the audio type of the next audio frame, that is, continue to adjust the recognition threshold during the process of recognizing the next audio frame, thereby achieving dynamic adjustment of the recognition threshold, and then the audio type is recognized according to the dynamically adjusted recognition threshold, which can improve the accuracy of recognition of audio type.

Referring to FIG. 2, FIG. 2 is a schematic flow chart of an audio processing method provided by an embodiment of the present disclosure. The method of this embodiment can be combined with multiple exemplary solutions of the audio processing method provided in the above embodiments. The audio processing method provided in this embodiment is refined. For example, determining the audio type of the audio frame based on the current recognition threshold includes: extracting audio characteristics of the audio frame, inputting the audio characteristics into the audio recognition model, and obtaining the recognition probability of the audio frame; and determining the audio type of the audio frame based on the current recognition threshold and the recognition probability.

As shown in FIG. 2, the method in this embodiment includes the following steps.
S210. Acquiring an audio frame to be processed.
S220. Extracting an audio characteristic of the audio frame, inputting the audio characteristic into an audio recognition model, and obtaining a recognition probability of the audio frame.
S230. Determining an audio type of the audio frame based on a current recognition threshold and the recognition probability.
S240. In a case that the current audio frame satisfies a threshold adjustment condition, determining a determination state of the recognized audio type based on characteristic information of recognized continuous audio frames.
S250. Adjusting the current recognition threshold according to the determination state, wherein the adjusted recognition threshold is configured to recognize the audio type of a next audio frame.

Among them, audio characteristics can be configured to determine the recognition probability of audio frames, and the audio characteristics can be obtained through a series of calculations and transformations. The audio characteristic extraction process may include but be not limited to windowing, fast Fourier transform, Mel-spectrum conversion, normalization, etc. The audio recognition model can be a fully trained deep learning model, including but not limited to a recurrent neural network model, a long short-term memory recurrent neural network, etc. The recognition probability of the audio frame can be configured to determine whether the audio frame is of a voice type.

Exemplarily, taking a specific application scenario as an example, the time length of the audio frame can be 10 ms, the sampling rate is 16 KHz, and the input of one audio frame is x(n), where n=0, 1, . . . , 160, that is, data of 160 sampling points. When performing windowing, the signal x(n) is multiplied by a window function w (n) to obtain a windowed signal x(n)*w(n). Among them, the window function can be a function such as Hanning window. When performing a fast Fourier transform, the fast Fourier transform is performed on the windowed signal to obtain a signal spectrum X(m)-FFT(x(n)*w(n)). When calculating the Mel-spectrum, the spectrum is divided into several segments, and energies of these segments are summed based on the Mel filter function to obtain the Mel-spectrum, which is then normalized to obtain the audio characteristics of the audio frame. The audio characteristics are input into the audio recognition model, and the recognition probability of the audio frame can be obtained.

For example, if the recognition probability is greater than or equal to the current recognition threshold, the audio type of the audio frame is the voice type; if the recognition probability is less than the current recognition threshold, the audio type of the audio frame is the noise type.

On the basis of the above embodiments, the training method of the audio recognition model includes: acquiring a noise-free audio, and setting tags for audio segments in the noise-free audio; acquiring noise information, and superposing the noise information to the noise-free audio to form a sample audio, wherein the noise information includes at least one of steady noise, transient noise, and howling noise; and iteratively training the audio recognition model based on the sample audio until a trained audio recognition model is obtained.

Among them, the howling noise is a feedback sound. For example, in a phone call scenario, if the sending and receiving devices are in the same physical space, howling is likely to occur. Traditional voice activity detection algorithms have difficulty in recognizing the howling, and hence do not have the ability to suppress a howling. In this embodiment, the audio recognition model is trained by superimposing the howling noise into the noise-free audio, and using the audio superimposed with the howling noise as the sample audio, so that the audio recognition model has the ability to determine a howling as a noise; in this way, the audio processing method has the ability to suppress a howling. For example, by adding various noise sample audios such as steady noise, transient noise, and howling noise, into the noise-free audio, the audio recognition model is trained to have the ability of recognizing the steady noise, the transient noise and the howling noise, which improves the robustness and applicability of the audio recognition model.

Exemplarily, the noise-free audio can include clean voice and blank audio. Audio frames in the clean voice that are greater than a preset threshold can be marked as 1, and other audio frames can be marked as 0. For example, noise information can be acquired, and the acquired noise information can be superimposed into the noise-free audio to form a sample audio. The tag of the sample audio is consistent with the tag of the noise-free audio, that is, the tag does not change.

In the process of iterative training of the audio recognition model, the focal loss can be used as the loss function, and the audio recognition model to be trained is iteratively trained based on the sample audio until a well-trained audio recognition model is obtained.

Based on the above embodiments, the method further includes: adjusting a signal-to-noise ratio in the sample audio; and/or filtering the sample audio based on a preset filter.

For example, by adjusting the signal-to-noise ratio in the sample audio, or by filtering the sample audio to varied degrees according to preset filters, the number of the audio samples can be increased, and the diversity of audio samples can be improved, so that the trained audio recognition model has stronger generalization ability. The signal-to-noise ratio in the sample audio can be adjusted randomly or by constant settings, and the preset filters can include but be not limited to high-pass filters, low-pass filters, etc.

In the technical solution of the embodiment of the present disclosure, the howling noise is superimposed into the noise-free audio, and the audio superimposed with the howling noise is used as the sample audio for training the audio recognition model, so that the audio recognition model has the ability to determine the howling noise as a noise, and thus the audio processing method has the ability to suppress howling.

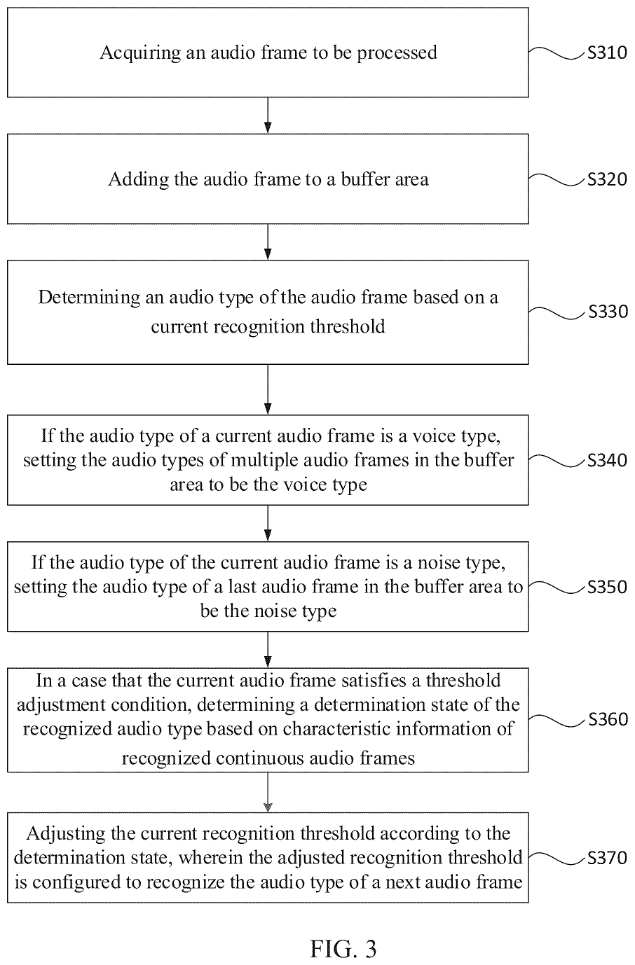

Referring to FIG. 3, FIG. 3 is a schematic flowchart of an audio processing method provided by an embodiment of the present disclosure. The method of this embodiment can be combined with multiple exemplary solutions of the audio processing method provided in the above embodiments. The audio processing method provided in this embodiment is refined. For example, after an audio frame to be processed is acquired, the audio frame is added to a buffer area, wherein the buffer area is configured to store multiple audio frames that are not output, the current audio frame is located in the last frame of the buffer area, and the first frame in the buffer area is the frame to be output. As shown in FIG. 3, the method in this embodiment includes the following steps.
S310. Acquiring an audio frame to be processed.
S320. Adding the audio frame to a buffer area.
S330. Determining an audio type of the audio frame based on a current recognition threshold.
S340. If the audio type of a current audio frame is a voice type, setting the audio types of multiple audio frames in the buffer area to be the voice type.
S350. If the audio type of the current audio frame is a noise type, setting the audio type of a last audio frame in the buffer area to be the noise type.
S360. In a case that the current audio frame satisfies a threshold adjustment condition, determining a determination state of the recognized audio type based on characteristic information of recognized continuous audio frames.
S370. Adjusting the current recognition threshold according to the determination state, wherein the adjusted recognition threshold is configured to recognize the audio type of a next audio frame.

The buffer area can be configured to store multiple audio frames that are not output, and the multiple audio frames are arranged in the buffer area based on timestamps.

It is to be noted that the embodiment of the present disclosure is a solution in which audio frames are added to the buffer area in real time, that is, the current audio frame is added to the buffer area at the same time when determining the audio type of the current audio frame. The current audio frame can be stored subsequent to the last recognized audio frame, that is, the newly added audio frame is always located in the last frame of the buffer area, and the first frame in the buffer area is set as the frame to be output; in this way, it ensures that the audio frames are output by following the adding sequence, that is, the audio frames are output according to the timing sequence, which can avoid disordered voice playback.

During the continuous recognition process of the audio frames, the recognition threshold is dynamically adjusted to improve the accuracy of the recognition threshold; correspondingly, during the recognition process of multiple audio frames in an initial stage of the audio, the recognition threshold is in an initial adjustment stage. In order to avoid incorrect recognition of multiple audio frames in the initial stage of the audio, if the audio type of the current audio frame is a voice type and it cannot be determined whether the current audio frame is an initial voice frame, the audio type of the currently cached audio frame in the buffer area is set to be a voice type, so as to avoid misrecognizing the voice frames as the noise frames in the initial audio recognition stage; if the audio type of the current audio frame is a noise type and the noise frame has no influence on the previous audio frame, the audio type of the audio frame in the buffer area corresponding to the current audio frame is set to be the noise type, that is, the audio type of the last audio frame in the buffer area is set to be the noise type. In the embodiment of the present disclosure, by setting the buffer area, a certain delay is provided for the audio output, and the audio type of the previous audio frame is updated through the audio type of the subsequent audio frame, so as to avoid the misrecognition of voice frames during the adjustment process of recognition threshold, which ensures the normal output of voice frames. The audio in this implementation can be a real-time output audio such as a phone call audio, a live-streaming audio, etc.

In some exemplary implementations of the embodiments of the present disclosure, after adjusting the current recognition threshold according to the determination state, the method further includes: determining a current threshold range in which the adjusted recognition threshold is located, and determining a length of the buffer area according to the current threshold range.

Among them, the current threshold range can be set based on experience, and the current threshold range can be compared with the adjusted recognition threshold. Since the recognition threshold is a dynamically changing value, the comparison result is also a dynamically changing value, and the length of the buffer area can be dynamically adjusted based on the comparison result. The length of the buffer area refers to the length of time that audio frames can be cached. It is to be noted that the adjustment of the length of the buffer area is actually an adjustment of audio output delay. In the embodiment of the present disclosure, by dynamically adjusting the length of the buffer area, it can avoid the situation where the voice at the beginning of the audio is misjudged as a noise. It can be understood that by adjusting the length of the buffer area and by catching different numbers of audio frames in the buffer area, a secondary correction of audio types of different numbers of audio frames can be achieved, thereby improving the accuracy of voice recognition.

Exemplarily, in some embodiments, the current threshold range may include a first threshold and a second threshold, and the first threshold is greater than the second threshold. If the adjusted recognition threshold is greater than the first threshold, it indicates that the current recognition of audio frame involves considerable error rate, and the length of the buffer area is set to be a first time length; if the adjusted recognition threshold is less than the second threshold, it indicates that the current recognition of audio frame involves small error rate, and the length of the buffer area is set to be a second time length, wherein the first time length can be greater than the second time length; under other situations, the length of the buffer area can remain unchanged. Among them, the first time length is greater than the second time length.

In some embodiments, if the adjusted recognition threshold is less than the first threshold and greater than the second threshold, the length of the buffer area may be set to be a third time length, and the third time length may be greater than the second time length and less than the first time length. In some embodiments, the current threshold range may include more than two thresholds, and the length of the buffer area is adjusted through the more than two thresholds.

Based on the above embodiment, the method further includes: in a case that the audio type of all the audio frames in the buffer area is the noise type, clearing the buffer area and rebuilding a buffer area based on the length of the current buffer area.

It is to be noted that by clearing the buffer area, all the noise in the buffer area can be removed, so as to prevent from an output of the noise; furthermore, a buffer area can be rebuilt based on the length of the current buffer area to continue caching subsequent audio frames, which can avoid caching confusion of voice and noise.

The technical solution of the embodiment of the present disclosure can achieve delayed output of audio frames by adding audio frames to the buffer area; if the audio type of the current audio frame is a voice type, the audio type of multiple audio frames in the buffer area is set to be the voice type; if the audio type of the current audio frame is a noise type, the audio type of the last audio frame in the buffer area is set to be the noise type, so as to realize the determination of whether the voice is ended; the length of the buffer area is determined according to the current threshold range so as to achieve dynamical adjustment of the audio output delay, which can avoid misjudgment at the beginning of a voice and improve the accuracy of recognition of voice type.

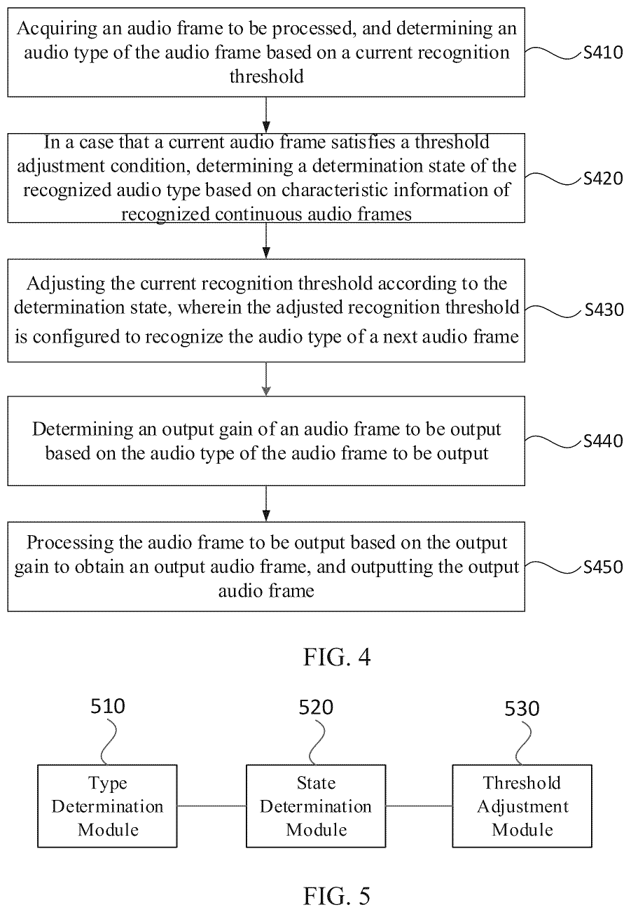

Referring to FIG. 4, FIG. 4 is a schematic flowchart of an audio processing method provided by an embodiment of the present disclosure. The method of this embodiment can be combined with multiple exemplary solutions of the audio processing method provided in the above embodiments. The audio processing method provided in this embodiment is refined. For example, the method further includes: determining an output gain of an audio frame to be output based on the audio type of the audio frame to be output; processing the audio frame to be output based on the output gain to obtain an output audio frame, and outputting the output audio frame. As shown in FIG. 4, the method in this embodiment includes the following steps.
S410. Acquiring an audio frame to be processed, and determining an audio type of the audio frame based on a current recognition threshold.
S420. In a case that a current audio frame satisfies a threshold adjustment condition, determining a determination state of the recognized audio type based on characteristic information of recognized continuous audio frames.
S430. Adjusting the current recognition threshold according to the determination state, wherein the adjusted recognition threshold is configured to recognize the audio type of a next audio frame.
S440. Determining an output gain of an audio frame to be output based on the audio type of the audio frame to be output.
S450: Processing the audio frame to be output based on the output gain to obtain an output audio frame, and outputting the output audio frame.

Among them, the audio frame to be output refers to the audio frame located at the first position in the buffer area. The output gain of the audio frame to be output can be configured to adjust an output state of the audio frame to be output to achieve noise reduction.

For example, in some embodiments, a regular corresponding relationship between audio type and output gain can be established in advance and a regular relationship table is generated; and the audio type of the audio frame to be output is matched in the regular relationship table to obtain the corresponding output gain. In some embodiments, the output gain of the audio frame to be output can also be determined based on a gain function model. The gain function model can calculate the output gain of a next audio frame to be output by using the output gain of the current audio frame to be output. In this way, dynamic adjustment of the output gain is realized, so that the output of the audio frame to be output is more natural.

In some exemplary implementations of the embodiments of the present disclosure, determining the output gain of the audio frame to be output based on the audio type of the audio frame to be output includes: in a case that the audio type of the audio frame to be output is a voice type, determining the output gain of the audio frame to be output to be a first preset value; in a case that the audio type of the audio frame to be output is a noise type, determining the output gain of the audio frame to be output to be a second preset value, wherein the first preset value is greater than the second preset value.

Exemplarily, the first preset value may be 1, and the second preset value may be 0. When the audio type of the audio frame to be output is a voice type, the output gain of the audio frame to be output may be set to 1, and the audio frame is output normally; when the audio type of the audio frame to be output is a noise type, the output gain of the audio frame to be output may be set to 0, and the audio frame is eliminated, so as to achieve the purpose of silence and noise reduction. It is to be noted that the first preset value and the second preset value here are only examples. The first preset value and the second preset value can also be other values such as 0.8 and 0.2, which are not intended to constitute any limitation.

In some exemplary implementations of the embodiments of the present disclosure, determining the output gain of the audio frame to be output based on the audio type of the audio frame to be output further includes: in a case that the audio type of the audio frame to be output is a noise type, and if a preset number of audio frames that have been output include audio frames of voice type, performing a smoothing process based on the output gain of a previous audio frame to be output, to obtain the output gain of the audio frame to be output.

Among them, the smoothing process can be performed to obtain a gradually changing output gain. Compared with the above method of setting constant first and second preset values, it can prevent the audio type from repeatedly jumping, and remove burr parts in the audio, so that the output of the audio frame to be output is more natural.

Exemplarily, the preset number may be N, that is, when the audio type of the audio frame to be output is the noise type, and a total of N audio frames of the voice type have been output before the audio frame to be output, the output gain of the audio frame to be output is determined according to the output gain of the previous audio frame that has been output. For example, by decreasing progressively based on the output gain of the previous audio frame that has been output, the output gain of the audio frame to be output is obtained. For example, if the output gain of the previous audio frame that has been output is 0.8, the output gain of the audio frame to be output can be obtained by subtracting a gain adjustment value, such as 0.2, from the output gain of the previous audio frame that has been output; and the resulting output gain of the audio frame to be output is 0.6. It is to be noted that the above value of the output gain and the decrement value are only examples and are not intended to constitute any limitation.

For example, the output gain obtained as above can be used to process the audio frame to be output, so as to obtain the output audio frame. The output audio frame can refer to the audio frame that needs to be output and played. The output method can include but be not limited to direct outputting from the current device, or transmitting to other devices for output through wired or wireless communication methods, etc.

Exemplarily, the output gain can be multiplied by a parameter value corresponding to the audio frame to be output, so as to perform noise reduction processing on the audio frame to be output. For example, if the output gain is 1, the audio frame to be output remains unchanged; and if the output gain is 0, the audio frame to be output is set to be zero, and is eliminated as a noise frame.

In the technical solution of the embodiment of the present disclosure, the output gain of the audio frame to be output is determined according to the audio type of the audio frame to be output, and the output gain can be configured to adjust the output state of the audio frame to be output, so as to achieve noise reduction processing and improve the quality of the output audio frame.

FIG. 5 is a schematical structural diagram of an audio processing apparatus provided by an embodiment of the present disclosure. As shown in FIG. 5, the apparatus includes:
a type determination module 510 configured to acquire an audio frame to be processed and determine an audio type of the audio frame based on a current recognition threshold;
a state determination module 520 configured to determine a determination state of the recognized audio type based on characteristic information of recognized continuous audio frames in a case that a current audio frame satisfies a threshold adjustment condition; and
a threshold adjustment module 530 configured to adjust the current recognition threshold according to the determination state, wherein the adjusted recognition threshold is configured to recognize the audio type of a next audio frame.

In some exemplary implementations of the embodiments of the present disclosure, the audio type includes a voice type and a noise type.

The threshold adjustment condition is that the audio type of the current audio frame is a noise type, and the audio type of a previous audio frame is a voice type.

In some exemplary implementations of the embodiments of the present disclosure, the state determination module 520 is further configured to:
determine characteristic information of continuous voice frames preceding the current audio frame, and compare the characteristic information with a determination threshold of the characteristic information; and
determine the determination state of the recognized audio type based on a comparison result.

In some exemplary implementations of embodiments of the present disclosure, the characteristic information includes one or more of the following: a length, a recognition probability, a fundamental frequency, and an energy value of the continuous voice frames.

In some exemplary implementations of embodiments of the present disclosure, the determination state includes an error state and a correct state; and the threshold adjustment module 530 is further configured to:
if the determination state is an error state, increase the current recognition threshold;
if the determination state is a correct state, reduce the current recognition threshold.

In some exemplary implementations of the embodiments of the present disclosure, after an audio frame to be processed is acquired, the audio frame is added to a buffer area, wherein the buffer area is configured to store multiple audio frames that have not been output, the current audio frame is the last frame located in the buffer area, and the first frame in the buffer area is the frame to be output.

In some exemplary implementations of embodiments of the present disclosure, the apparatus is further configured to:
if the audio type of the current audio frame is the voice type, set the audio types of the multiple audio frames in the buffer area to be the voice type; and
if the audio type of the current audio frame is the noise type, set the audio type of the last audio frame in the buffer area to be the noise type.

In some exemplary implementations of embodiments of the present disclosure, the apparatus is further configured to:
determine a current threshold range in which the adjusted recognition threshold is located, and determine a length of the buffer area according to the current threshold range.

In some exemplary implementations of embodiments of the present disclosure, the apparatus is further configured to:
in a case that the audio type of all the audio frames in the buffer area is the noise type, clear the buffer area, and rebuild a buffer area based on a length of a current buffer area.

In some exemplary implementations of embodiments of the present disclosure, the apparatus further includes:
a gain determination module configured to determine an output gain of an audio frame to be output based on the audio type of the audio frame to be output; and
an audio output module configured to process the audio frame to be output based on the output gain to obtain an output audio frame, and output the output audio frame.

In some exemplary implementations of embodiments of the present disclosure, the gain determination module is further configured to:
in a case that the audio type of the audio frame to be output is a voice type, determine the output gain of the audio frame to be output to be a first preset value; and
in a case that the audio type of the audio frame to be output is a noise type, determine the output gain of the audio frame to be output to be a second preset value, wherein the first preset value is greater than the second preset value.

In some exemplary implementations of embodiments of the present disclosure, the gain determination module is further configured to:
in a case that the audio type of the audio frame to be output is the noise type, and a preset number of audio frames that have been output include audio frames of the voice type, perform a smoothing process based on the output gain of a previous audio frame to be output to obtain the output gain of the audio frame to be output.

In some exemplary implementations of embodiments of the present disclosure, the type determination module 510 is further configured to:
extract an audio characteristic of the audio frame, and input the audio characteristic into an audio recognition model to obtain a recognition probability of the audio frame; and
determine the audio type of the audio frame based on the current recognition threshold and the recognition probability.

In some exemplary implementations of embodiments of the present disclosure, a training device of the audio recognition model includes:
a tag setting module configured to acquire a noise-free audio, and set tags for audio segments in the noise-free audio;
a sample production module configured to acquire noise information, and superimpose the noise information into the noise-free audio to form a sample audio, wherein the noise information includes at least one of steady noise, transient noise, and howling noise; and
a model training module configured to iteratively train the audio recognition model to be trained based on the sample audio until a trained audio recognition model is obtained.

In some exemplary implementations of the embodiments of the present disclosure, the training device of the audio recognition model may further be configured to:
adjust a signal-to-noise ratio in the sample audio; and/or,
filter the sample audio based on a preset filter.

The audio processing apparatus provided by the embodiments of the present disclosure can execute the audio processing method provided by any embodiment of the present disclosure, and has corresponding functional modules and beneficial effects for executing the method.

It is worth noting that the multiple units and modules included in the above apparatus are only classified according to functional logic, but are not limited to the above classification, as long as they can achieve the corresponding functions; in addition, the specific names of the multiple functional units are only used to facilitate mutual differentiation and are not used to limit the scope of the embodiments of the present disclosure.

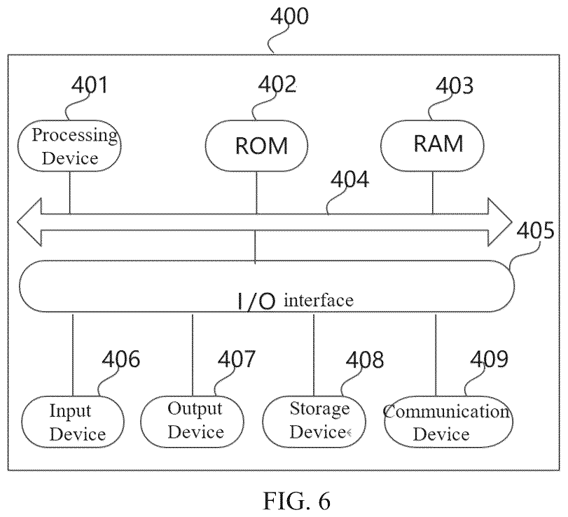

Referring now to FIG. 6, a schematic structural diagram of an electronic device (such as the terminal device or server in FIG. 6) 400 suitable for implementing embodiments of the present disclosure is shown. The terminal devices in the embodiments of the present disclosure may include, but be not limited to, mobile phones, laptops, digital broadcast receivers, PDAs (Personal Digital Assistants), PADs (Tablets), PMPs (Portable Multimedia Players), vehicle-mounted terminals (such as vehicle-mounted navigation terminals), etc., and regular terminals such as digital TVs, desktop computers, etc. The electronic device shown in FIG. 6 is only an example and should not impose any limitations on the functions and scope of usage of the embodiments of the present disclosure.

As shown in FIG. 6, the electronic device 400 may include a processing device (e.g., central processing unit, graphics processor, etc.) 401, which can execute various appropriate actions and processes according to a program stored in a read-only memory (ROM) 402 or a program loaded from a storage device 408 to a random-access memory (RAM) 403. In the RAM 403, various programs and data required for the operation of the electronic device 400 are also stored. The processing device 401, the ROM 402, and the RAM 403 are connected to each other via a bus 404. An input/output (I/O) interface 405 is also connected to the bus 404.

Generally, the following devices may be connected to the I/O interface 405: an input device 406 including, for example, a touch screen, a touch pad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to have wireless or wired communication with other devices to exchange data. Although FIG. 6 illustrates an electronic device 400 provided with various devices, it is to be understood that it is not required of implementation or availability of all the illustrated devices. More or fewer devices may alternatively be implemented or provided.

According to embodiments of the present disclosure, the processes described above with reference to the flowcharts may be implemented as a computer software program. For example, embodiments of the present disclosure include a computer program product including a computer program carried on a non-transitory computer-readable medium, the computer program containing program codes for performing the method illustrated in the flowcharts. In these embodiments, the computer program may be downloaded and installed from the network via the communication device 409, or installed from the storage device 408, or installed from the ROM 402. When the computer program is executed by the processing device 401, the above-mentioned functions defined in the method of the embodiments of the present disclosure are performed.

The electronic device provided by the embodiments of the present disclosure and the audio processing method provided by the above embodiments belong to the same concept. Technical details that are not described in detail in this embodiment can be referred to the above embodiments, and this embodiment has the same beneficial effects as the above embodiments.

Embodiments of the present disclosure provide a computer storage medium on which a computer program is stored. When the program is executed by a processor, the audio processing method provided by the above embodiments is implemented.

It is to be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any computer-readable medium other than the computer-readable storage medium. The computer-readable signal medium may send, propagate or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future, such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs. When the above-mentioned one or more programs are executed by the electronic device, the electronic device is configured for:
acquiring an audio frame to be processed and determining an audio type of the audio frame based on a current recognition threshold;
in a case that a current audio frame satisfies a threshold adjustment condition, determining a determination state of the recognized audio type based on characteristic information of recognized continuous audio frames; and
adjusting the current recognition threshold according to the determination state, wherein the adjusted recognition threshold is configured to recognize the audio type of a next audio frame.

Computer program codes for performing the operations of the present disclosure may be written in one or more programming languages or a combination thereof, including but not limited to object-oriented programming languages such as Java, Smalltalk, C++, and conventional procedural programming languages such as “C” or similar programming languages. The program codes may be executed entirely on the user's computer, partly on the user's computer, as a stand-alone software package, partly on the user's computer and partly on a remote computer, or entirely on a remote computer or server. In situations involving remote computers, the remote computer can be connected to the user's computer through any kind of network, including a local area network (LAN) or a wide area network (WAN), or it can be connected to an external computer (such as an Internet service provider through Internet connection).

The flowcharts and block diagrams in the figures illustrate the architecture, functionality, and operations of possible implementations of systems, methods, and computer program products according to various embodiments of the present disclosure. In this regard, each block in the flowchart or block diagrams may represent a module, a program segment, or a portion of code which contains one or more executable instructions for implementing specified logic functions. It is also to be noted that, in some alternative implementations, the functions labeled in the block may be performed in a sequence different from those labeled in the figures. For example, two blocks shown one after another may actually be executed substantially in parallel, or they may sometimes be executed in a reverse order, depending on the functionality involved. It will also be noted that each block of the block diagram and/or flowchart, and combinations of blocks in the block diagram and/or flowchart illustration, can be implemented by special purpose hardware-based systems that perform the specified functions or operations, or can be implemented by using a combination of specialized hardware and computer instructions.

The units involved in the embodiments of the present disclosure can be implemented in software or hardware. Among them, the name of the unit/module does not constitute a limitation on the unit itself under certain circumstances.

The functions described above in the present disclosure may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable medium may include, but be not limited to, electronic, magnetic, optical, electromagnetic, infrared, or semiconductor systems, apparatuses or devices, or any suitable combination of the foregoing. More specific examples of machine-readable storage medium may include one or more wire-based electrical connections, laptop disks, hard drives, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

According to one or more embodiments of the present disclosure, [Example 1] provides an audio processing method, including:
acquiring an audio frame to be processed and determining an audio type of the audio frame based on a current recognition threshold;
in response to a determination that a current audio frame satisfies a threshold adjustment condition, determining a determination state of a recognized audio type based on characteristic information of recognized continuous audio frames; and
adjusting the current recognition threshold according to the determination state, wherein the adjusted recognition threshold is configured to recognize the audio type of a next audio frame.

According to one or more embodiments of the present disclosure, [Example 2] provides an audio processing method, wherein
the audio type includes a voice type and a noise type; and
the threshold adjustment condition includes: the audio type of the current audio frame is the noise type, and the audio type of a previous audio frame is the voice type.

According to one or more embodiments of the present disclosure, [Example 3] provides an audio processing method, wherein
the determining the determination state of the recognized audio type based on the characteristic information of the recognized continuous audio frames includes:
determining characteristic information of continuous voice frames preceding the current audio frame, and comparing the characteristic information with a determination threshold of the characteristic information; and
determining the determination state of the recognized audio type based on a comparison result.

According to one or more embodiments of the present disclosure, [Example 4] provides an audio processing method, wherein
the characteristic information includes one or more of the following: a length, a recognition probability, a fundamental frequency, and an energy value of the continuous voice frames.

According to one or more embodiments of the present disclosure, [Example 5] provides an audio processing method, wherein
the determination state includes an error state and a correct state;
the adjusting the current recognition threshold according to the determination state includes:
in response to a determination that the determination state is the error state, increasing the current recognition threshold; and
in response to a determination that the determination state is the correct state, decreasing the current recognition threshold.

According to one or more embodiments of the present disclosure, [Example 6] provides an audio processing method, after acquiring the audio frame to be processed, further including:
adding the audio frame to a buffer area;
wherein the buffer area is configured to store a plurality of audio frames that have not been output, the current audio frame is located at a last frame of the buffer area, and a first frame in the buffer area is an audio frame to be output.

According to one or more embodiments of the present disclosure, [Example 7] provides an audio processing method, after determining the audio type of the audio frame based on the current recognition threshold, further including:
in response to a determination that the audio type of the current audio frame is a voice type, setting the audio type of the plurality of audio frames in the buffer area to be the voice type; and
in response to a determination that the audio type of the current audio frame is a noise type, setting the audio type of a last audio frame in the buffer area to be the noise type.

According to one or more embodiments of the present disclosure, [Example 8] provides an audio processing method, after adjusting the current recognition threshold according to the determination state, further including:
determining a current threshold range in which the adjusted recognition threshold is located, and determining a length of the buffer area according to the current threshold range.

According to one or more embodiments of the present disclosure, [Example 9] provides an audio processing method, further including:
in response to a determination that the audio type of the plurality of audio frames in the buffer area is a noise type, clearing the buffer area, and rebuilding a buffer area based on a length of a current buffer area.

According to one or more embodiments of the present disclosure, [Example 10] provides an audio processing method, further including:
determining an output gain of the audio frame to be output based on the audio type of the audio frame to be output; and
processing the audio frame to be output based on the output gain to obtain an output audio frame, and outputting the output audio frame.

According to one or more embodiments of the present disclosure, [Example 11] provides an audio processing method, wherein
the determining the output gain of the audio frame to be output based on the audio type of the audio frame to be output includes:
in a case that the audio type of the audio frame to be output is a voice type, determining that the output gain of the audio frame to be output is a first preset value;
in a case that the audio type of the audio frame to be output is a noise type, determining that the output gain of the audio frame to be output is a second preset value, wherein the first preset value is greater than the second preset value.

According to one or more embodiments of the present disclosure, [Example 12] provides an audio processing method, wherein
the determining the output gain of the audio frame to be output based on the audio type of the audio frame to be output further includes:
in a case that the audio type of the audio frame to be output is the noise type, if a preset number of audio frames having been output include audio frames of the voice type, performing a smoothing process based on an output gain of a previous audio frame to be output, to obtain the output gain of the audio frame to be output.

According to one or more embodiments of the present disclosure, [Example 13] provides an audio processing method, wherein
the determining the audio type of the audio frame based on the current recognition threshold includes:
extracting an audio characteristic of the audio frame, and inputting the audio characteristic into an audio recognition model to obtain a recognition probability of the audio frame; and
determining the audio type of the audio frame based on the current recognition threshold and the recognition probability.

According to one or more embodiments of the present disclosure, [Example 14] provides an audio processing method, wherein
a training method of the audio recognition model includes:
acquiring a noise-free audio and setting tags for audio segments in the noise-free audio;
acquiring noise information and superimposing the noise information into the noise-free audio to form a sample audio, wherein the noise information includes at least one of steady noise, transient noise, and howling noise; and
iteratively training the audio recognition model to be trained based on the sample audio until a trained audio recognition model is obtained.

According to one or more embodiments of the present disclosure, [Example 15] provides an audio processing method, further including at least one of the following:
adjusting a signal-to-noise ratio in the sample audio; and
filtering the sample audio based on a preset filter.

According to one or more embodiments of the present disclosure, [Example 16] provides an audio processing apparatus, including:
a type determination module, configured to acquire an audio frame to be processed and determine an audio type of the audio frame based on a current recognition threshold;
a state determination module, configured to determine a determination state of the recognized audio type based on characteristic information of recognized continuous audio frames in response to a determination that a current audio frame satisfies a threshold adjustment condition; and
a threshold adjustment module, configured to adjust the current recognition threshold according to the determination state, wherein the adjusted recognition threshold is configured to recognize the audio type of a next audio frame.

Furthermore, although various operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Vice versa, various features that are described in the context of a single embodiment can also be implemented in multiple embodiments separately or in any suitable sub-combination.

What is claimed is:

1. An audio processing method, comprising:
acquiring an audio frame to be processed and determining an audio type of the audio frame based on a current recognition threshold;
in response to a determination that a current audio frame satisfies a threshold adjustment condition, determining a determination state of a recognized audio type based on characteristic information of recognized continuous audio frames; and
adjusting the current recognition threshold according to the determination state, wherein the adjusted recognition threshold is configured to recognize the audio type of a next audio frame.

2. The method according to claim 1, wherein the audio type comprises a voice type and a noise type; and
the threshold adjustment condition comprises: the audio type of the current audio frame is the noise type, and the audio type of a previous audio frame is the voice type.

3. The method according to claim 2, wherein the determining the determination state of the recognized audio type based on the characteristic information of the recognized continuous audio frames comprises:
determining characteristic information of continuous voice frames preceding the current audio frame, and comparing the characteristic information of continuous voice frames with a determination threshold of the characteristic information; and
determining the determination state of the recognized audio type based on a comparison result.

4. The method according to claim 3, wherein the characteristic information comprises one or more of the following: a length, a recognition probability, a fundamental frequency, and an energy value of the continuous voice frames.

5. The method according to claim 1, wherein the determination state comprises an error state and a correct state;
the adjusting the current recognition threshold according to the determination state comprises:
in response to a determination that the determination state is the error state, increasing the current recognition threshold; and
in response to a determination that the determination state is the correct state, decreasing the current recognition threshold.

6. The method according to claim 1, after acquiring the audio frame to be processed, further comprising:
adding the audio frame to a buffer area;
wherein the buffer area is configured to store a plurality of audio frames that have not been output, the current audio frame is located at a last frame of the buffer area, and a first frame in the buffer area is an audio frame to be output.

7. The method of claim 6, after determining the audio type of the audio frame based on the current recognition threshold, further comprising:
in response to a determination that the audio type of the current audio frame is a voice type, setting the audio type of the plurality of audio frames in the buffer area to be the voice type; and
in response to a determination that the audio type of the current audio frame is a noise type, setting the audio type of a last audio frame in the buffer area to be the noise type.

8. The method according to claim 6, after adjusting the current recognition threshold according to the determination state, further comprising:
determining a current threshold range in which the adjusted recognition threshold is located, and determining a length of the buffer area according to the current threshold range.

9. The method of claim 6, further comprising:
in response to a determination that the audio type of the plurality of audio frames in the buffer area is a noise type, clearing the buffer area, and reconstructing a buffer area based on a length of a current buffer area.

10. The method according to claim 6, further comprising:
determining an output gain of the audio frame to be output based on the audio type of the audio frame to be output; and
processing the audio frame to be output based on the output gain to obtain an output audio frame, and outputting the output audio frame.

11. The method according to claim 10, wherein the determining the output gain of the audio frame to be output based on the audio type of the audio frame to be output comprises:
in response to a determination that the audio type of the audio frame to be output is a voice type, determining that the output gain of the audio frame to be output is a first preset value;
in response to a determination that the audio type of the audio frame to be output is a noise type, determining that the output gain of the audio frame to be output is a second preset value, wherein the first preset value is greater than the second preset value.

12. The method according to claim 11, wherein the determining the output gain of the audio frame to be output based on the audio type of the audio frame to be output further comprises:
in response to a determination that the audio type of the audio frame to be output is the noise type, and a preset number of audio frames having been output comprising an audio frame of the voice type, performing a smoothing process based on an output gain of a previous audio frame to be output, to obtain the output gain of the audio frame to be output.

13. The method according to claim 1, wherein the determining the audio type of the audio frame based on the current recognition threshold comprises:
extracting an audio characteristic of the audio frame, and inputting the audio characteristic into an audio recognition model to obtain a recognition probability of the audio frame; and
determining the audio type of the audio frame based on the current recognition threshold and the recognition probability.

14. The method according to claim 13, wherein a training method of the audio recognition model comprises:
acquiring a noise-free audio and setting tags for audio segments in the noise-free audio;
acquiring noise information and superimposing the noise information into the noise-free audio to form a sample audio, wherein the noise information comprises at least one of steady noise, transient noise, and howling noise; and
iteratively training the audio recognition model to be trained based on the sample audio until a trained audio recognition model is obtained.

15. The method according to claim 14, further comprising at least one of the following:
adjusting a signal-to-noise ratio in the sample audio; and
filtering the sample audio based on a preset filter.

16. (canceled)

17. An electronic device, comprising:
one or more processors; and
a storage device configured to store one or more programs, wherein
when the one or more programs are executed by the one or more processors, the one or more processors are configured to implement an audio processing, comprising:
acquiring an audio frame to be processed and determining an audio type of the audio frame based on a current recognition threshold;
in response to a determination that a current audio frame satisfies a threshold adjustment condition, determining a determination state of a recognized audio type based on characteristic information of recognized continuous audio frames; and
adjusting the current recognition threshold according to the determination state, wherein the adjusted recognition threshold is configured to recognize the audio type of a next audio frame.

18. A non-transient computer-readable storage medium comprising computer-executable instructions, wherein
the computer-executable instructions, when executed by a computer processor, are configured to implement an audio processing method, comprising:
acquiring an audio frame to be processed and determining an audio type of the audio frame based on a current recognition threshold;
in response to a determination that a current audio frame satisfies a threshold adjustment condition, determining a determination state of a recognized audio type based on characteristic information of recognized continuous audio frames; and
adjusting the current recognition threshold according to the determination state, wherein the adjusted recognition threshold is configured to recognize the audio type of a next audio frame.

19. The electronic device according to claim 17, wherein in the audio processing method, the audio type comprises a voice type and a noise type; and
the threshold adjustment condition comprises: the audio type of the current audio frame is the noise type, and the audio type of a previous audio frame is the voice type.

20. The electronic device according to claim 19, wherein in the audio processing method, the determining the determination state of the recognized audio type based on the characteristic information of the recognized continuous audio frames comprises:
determining characteristic information of continuous voice frames preceding the current audio frame, and comparing the characteristic information of continuous voice frames with a determination threshold of the characteristic information; and
determining the determination state of the recognized audio type based on a comparison result.

21. The electronic device according to claim 20, wherein in the audio processing method, the characteristic information comprises one or more of the following: a length, a recognition probability, a fundamental frequency, and an energy value of the continuous voice frames.
